(19) United States
(12) Patent Application Publication
(10) Pub. No.: US 2026/0076320 A1
(43) Pub. Date: Mar. 19, 2026

(54) VISION BASED IRRIGATION

(71) Applicant: Deere & Company, Moline, IL (US)

(72) Inventors: RITESH S. KONDEKAR, PUNE (IN); SYED GOUSE MOIDDIN, PUNE (IN); RICHARD J. LAWLER, St. Augustine, FL (US)

(21) Appl. No.: 19/248,967

(22) Filed: Jun. 25, 2025

(30) Foreign Application Priority Data
Sep. 19, 2024 (IN) 202421070746

(51) Int. Cl. A01G 25/16; A01B 69/04; A01C 23/00; A01C 23/04; A01G 25/09

(52) U.S. Cl. CPC A01G 25/16; A01B 69/008; A01G 25/09; A01C 23/007; A01C 23/042

(57) ABSTRACT

A work machine for irrigation of saplings in silviculture. A work machine comprising a chassis along with a propulsion system and ground-engaging elements. A hydrating module is coupled to the chassis. The hydrating module comprises a hydrating fluid storage tank, a fluid delivery member, a drive mechanism to move hydrating fluid delivery member relative to the chassis and a hydrating control unit. A sensor is coupled to the chassis and the sensor is configured to observe the ground to identify a sapling. The sensor outputs a signal when a sapling is identified. The hydrating control unit controls a position of the fluid delivery member to maintain a non-relative motion with respect to the sapling while the work machine traverses the field. Simultaneously, a predetermined quantity of hydrating fluid is delivered through the fluid delivery member.

### CROSS-REFERENCE TO RELATED APPLICATIONS

This application claims priority under 35 U.S.C. § 119 to patent application IN 202421070746, filed on 19 Sep. 2024, the disclosure of which is incorporated herein by reference.

### FIELD OF THE DISCLOSURE

The present disclosure relates generally to silviculture and more particularly to vision based irrigation systems using a work machine.

### BACKGROUND OF THE DISCLOSURE

The silviculture process can be slow, cumbersome, and may require careful handling because the process involves planting fragile saplings into the ground. Furthermore, precision in planting depth, subsequent watering, fertilization, water retention around the sapling, and adequate spacing between saplings are some of many variables adding to the complexity to optimize the survival rates and growth of saplings once planted. Saplings can generally be sensitive to environmental conditions, handling, and conditions of planting. Generally done by hand, therein lies a need for an automated or semi-automated process to efficiently and carefully plant a multitude of saplings into the ground to support reforestation efforts.

Mechanization of various activities of silviculture has been improving over the years and various models of sapling planting machines were developed to plant large number of saplings within a short span of time. These machines handle the sapling with care and avoid any damage. Known planting machines carry huge volumes of water to hydrate the sapling while planting the sapling.

The planting machines hydrate the saplings while planting, but it is not efficient to use the same planting machine to supply water to the planted saplings at a later time after planting is complete. Typically, a water cart is drawn by a tractor and water is supplied to each sapling and is controlled manually.

Large numbers of saplings, which are planted over vast regions, need to be watered periodically. To fulfill such a requirement, an efficient watering solution is required.

Hence, there is a requirement for a novel mechanized and automated watering device that addresses the issues associated with the existing sapling irrigation systems.

### SUMMARY OF THE DISCLOSURE

An object of the present disclosure is to provide a work machine to irrigate saplings with accuracy and speed.

Another object of the present disclosure is to provide a vision system to recognize a sapling on the ground and output a signal to control release of water to the sapling.

Another object of the present disclosure is to provide a mechanism to supply water to a sapling through a fluid delivering member and control the position of the fluid delivering member with respect to the sapling while the work machine is moving.

Yet another object of the present disclosure is to optimize the operation of sapling watering.

In accordance with the present disclosure, an irrigation method and system using a work machine is provided.

The work machine comprises a chassis along with a propelling unit and ground-engaging elements. A hydrating module is attached to the chassis. The hydrating module comprises a hydrating fluid storage tank, a fluid delivery member, a drive mechanism to move a hydrating fluid delivery member relative to the chassis and a hydrating control unit. A sensor is attached to the chassis and the sensor is configured to observe the ground to identify a sapling. The sensor outputs a signal when a sapling is identified above the ground. The hydrating control unit controls a position of the fluid delivery member to maintain a non-relative motion with respect to the sapling while the work machine traverse the field. Simultaneously, a predetermined quantity of hydrating fluid is delivered through the fluid delivery member.

A camera is used to sense the sapling on the ground. An image analysis system is used to identify a sapling. The sensor generates a signal that includes a position of the sapling with respect to the chassis.

The fluid delivery member comprises a plurality of nozzles to distribute the fluid flow around the sapling.

The work machine further comprises a steering system for steering the work machine according to a pre-recorded path. The pre-recorded path could be recorded during planting of the saplings.

Other features and aspects will become apparent by consideration of the detailed description and accompanying drawings.

### BRIEF DESCRIPTION OF THE DRAWINGS

FIG. 1 illustrates a side view of a work machine with a fluid delivery member coupled at rear end;

FIG. 2 illustrates a side view of a work machine in a working condition;

FIG. 3 illustrates a perspective view of a drive mechanism for the fluid delivery member;

FIG. 4 illustrates a side view of the fluid delivery member and vision sensor;

FIG. 5a illustrates control circuits for the hydrating module;

FIG. 5b illustrates control circuits for the hydrating module; and

FIG. 6 illustrates a flow chart explaining the operation of a sapling irrigation system.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

As used herein, the term “controller” is a computing device including a processor and a memory. The “controller” may be a single device or alternatively multiple devices.

As used herein, the term “module” refers to any hardware, software, firmware, electronic control component, processing logic, processing device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

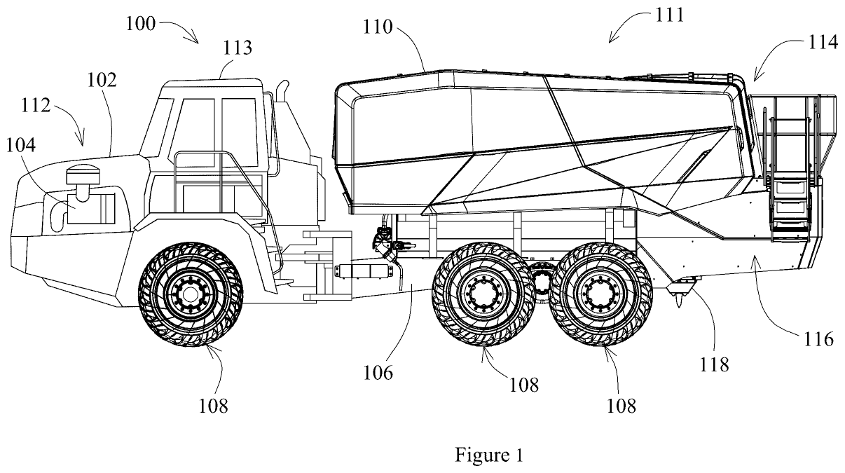

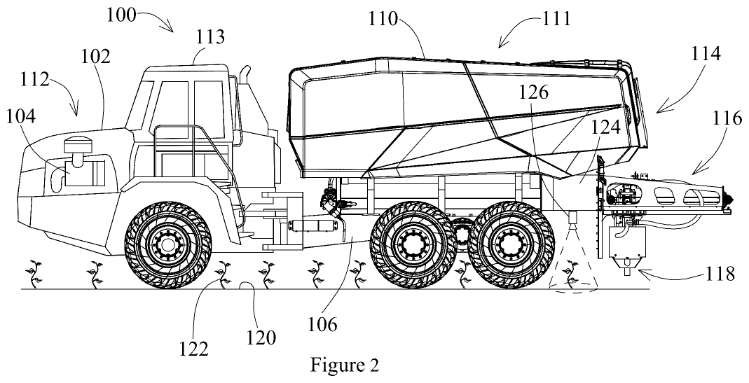

FIGS. 1 and 2 illustrate a work machine 100 comprising an irrigation system. A hydrating module 111 is attached at a rear end 114 of the work machine 100, according to one embodiment. It is intended that the hydrating module 111 spray water or a hydrating fluid 110a for each sapling 122 wherein the work machine 100 continues to advance along the ground 120 in a forward direction, thereby advantageously reducing fuel consumption and increasing efficiency by minimizing a stop/start of the work machine 100 when spraying water or hydrating fluid 110a to each sapling 122. An alternative embodiment of an irrigation system may comprise a hydrating module 111 coupled to a work machine 100, such as a tractor, rather than a singular piece of equipment. Therein, the term work machine 100 may include a hydrating module 111 attached to a work machine 100, or a work machine 100 towing a hydrating module 111. Note that the hydrating module is one of several subcomponents found within the irrigation system. Furthermore, the terms “work machine,” “irrigation vehicle” and “irrigation machine” may be used interchangeably throughout this disclosure.

The work machine 100 may comprise of one or more subcomponents and/or subsystems described herein to automate or semi-automate the irrigation process. The present disclosure includes a work machine 100 with multiple subsystems. However, used holistically or in part, these subsystems provide an improved process for irrigating multiple saplings 122 through the automated or a semi-automated process. The work machine 100 may include a chassis 106, ground-engaging elements 108, such as wheels, and a propulsion system 104. The propulsion system 104, such as a diesel engine or an electric engine, provides motive power driving the ground-engaging elements 108 and for operating the other components associated with the work machine 100, such as actuators. An operator cab 113, or alternatively a remote operating station (not shown) where an operator sits when operating the work machine 100, includes a user input interface with a plurality of controls (e.g. steering, switches, joysticks, pedals, buttons, levers, display screens, etc.) for controlling the work machine 100 during operation thereof.

FIG. 2 illustrates the work machine 100 on the ground 120 with saplings 122. The operator drives the work machine 100 along the row of saplings 122 for supplying water or hydrating fluid 110a to each sapling 122 in the row. For each row, the operator drives the work machine 100 such that the fluid delivery member 118 is positioned close to the saplings 122. In an embodiment, the fluid delivery member 118 is at rear end 114 of the work machine 100 and at a middle point in a width direction of the work machine 100. In such case, the work machine 100 is steered such that the row of saplings 122 comes at the center of the vehicle width. The steering system of the work machine 100 could be an automatic system controlled by a controller that steers the work machine 100 according to various inputs. The steering inputs may comprise any individual or a combination of inputs given by the vehicle operator, predetermined map of path and sensors which detect the terrain/ground 120 and/or saplings 122 upfront of the work machine 100 and derive a preferred path. At least one camera is installed on the vehicle chassis 106 to observe the ground 120.

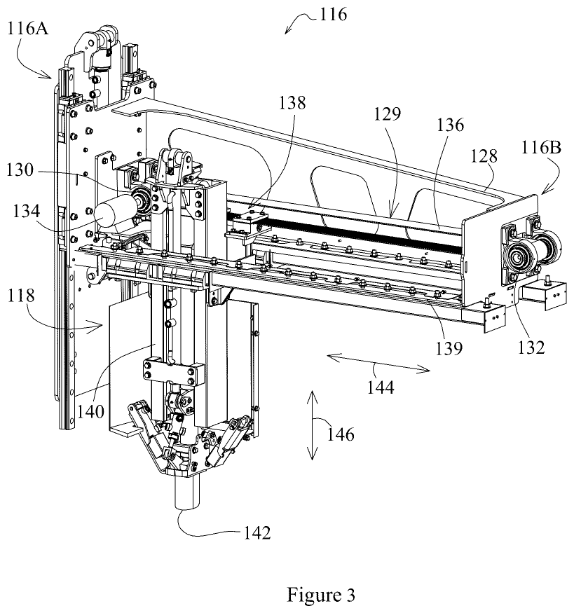

As depicted in FIGS. 1 and 2, the forward portion 112 or direction of the work machine 100 is generally to the left of the drawing and the rearward portion or rear end 114 or direction of the work machine 100 is generally to the right of the drawing. The work machine 100 may further include an external housing, which generally shields various subcomponents of the work machine 100 from dust, debris, winds, rain, and other harsh environmental conditions. The primary subcomponents and subsystems may include a hydrating module 111 attached to the chassis 106. The hydrating module 111 may further comprise a hydrating fluid storage tank 110, a fluid delivery system 116 including the fluid delivery member 118, and a drive mechanism 129 (FIG. 3) for driving the fluid delivery member 118. The work machine 100 may further comprise a hydrating control unit 102 to control various operations of the work machine 100 and the hydrating module 111.

The controller or control unit or hydrating control unit 102 may have one or more microprocessor-based electronic control units or controllers which perform calculations and comparisons and execute instructions. The hydrating control unit 102 may also include a processor, a core, volatile and non-volatile memory, digital and analog inputs, and digital and analog outputs. The hydrating control unit 102 may connect to and communicate with various input and output devices including, but not limited to, switches, relays, solenoids, actuators, light emitting diodes (LED's), liquid crystal displays (LCD's) and other types of displays, radio frequency devices (RFD's), sensors, and other controllers. The hydrating control unit 102 may receive communication or signals, via electrically or any suitable electromagnetic communication, from one or more devices, determine an appropriate response or action, and send communication or signals to one or more devices. The hydrating control unit 102 can be a programmable logic controller, also known as a PLC or programmable controller. The hydrating control unit 102 may couple to a separate work machine electronic control system through a data bus, such as a CAN bus, or the hydrating control unit 102 can be a part of the work machine electronic control system. The hydrating control unit 102 may further include an image analysis system to process the images from the image sensors.

The hydrating control unit 102 may be in communication with one or more devices including, but not limited to, a vehicle speed sensor to receive information about the vehicle speed; position/proximity sensors to receive various positional inputs of various sub systems such as the drive mechanism and fluid delivery member 118; geo-location sensors to receive information about the irrigation vehicle's location; obstruction detector sensors; the pump and/or pump controller to provide commands or instructions and/or receive information about direction and flow of hydrating fluid to and from the hydrating fluid storage tank; inputs from cameras; and the user input interface to receive commands or instructions and provide feedback. The hydrating control unit 102 may receive communication from and provide communications, controls, or instructions to any of these devices and any of the subcomponents. This list is not all-inclusive and is detailed further below. It is contemplated that various control units or processing units mentioned in this disclosure such as control unit, hydrating control unit, image analysis system or not necessarily separate units but a single control unit may handle all the processing or control talks.

In an embodiment, the work machine may be used to supply a hydrating fluid 110a to an entity. The entity may include but not be limited to a sapling, plant, tree, weed, stump and a stubble. The camera and the hydrating control unit 102 may be configured to detect a given entity on the ground 120 and generate a signal accordingly. The work machine operator may select an entity type to be watered or supplied with hydrating fluid 110a and the irrigation system will continue to work as described. This way, the work machine 100 may be used as a multipurpose dispenser.

FIG. 3 shows construction and working principle of the fluid delivery system 116. In an embodiment, the fluid delivery system 116 is attached to the rear end 114 of the work machine 100 and has a frame 128 to support the fluid delivery member 118 and a drive mechanism 129 to move the fluid delivery member 118. The frame 128 may have a first end 116A and a second end 116B, and the first end 116A is attached to the rear end 114 of the work machine 100. The drive mechanism 129 is placed within the frame 128. In an embodiment, the drive mechanism 129 may be a belt 136 and comprises a drive pulley 130 mounted at the first end 116A of the frame 128 and an idler pulley 132 mounted at the second end 116B of the frame 128. A motor 134 is mounted on the frame 128 and is connected to the drive pulley 130 and further drives the belt 136 over the drive pulley 130 and the idler pulley 132.

The fluid delivery member 118 is supported on the frame 128 via bearing surfaces 139. The bearing surfaces 139 allow a smooth movement of the fluid delivery member 118 along the length of the frame 128 in linear direction 144. The fluid delivery member 118 is coupled to the belt 136 via a block 138 such that the motion of the belt 136 is transferred to the fluid delivery member 118 through the block 138 in the linear direction 144. With this arrangement, as the motor 134 turns the drive pulley 130 the belt 136 runs between the drive pulley 130 and idler pulley 132. As the belt 136 moves between the pulleys, the block 138 moves the fluid delivery member 118 in the linear direction 144. Thus, by controlling the motor rotation, the fluid delivery member 118 can be displaced between first end 116A and second end 116B of the frame 128. In an embodiment, while the work machine 100 is moving forward and by driving the fluid delivery member 118 in rearward direction along with controlling the speed of the motor, position of the fluid delivery member 118 could be maintained such that the fluid delivery member 118 achieves a no-relative motion with respect to a location on ground 120 though the vehicle is moving in a forward direction. In an embodiment, the fluid delivery member 118 includes a nozzle 142 coupled to the bottom end. A vertical position of the nozzle 142 may be adjusted by means of an actuator 140 by extending or retracting the actuator in a vertical direction 146. It is contemplated that other variations of the components described above may be used, or any other mechanism for example a rotating screw and follower mechanism or a linear actuator may be used to achieve a linear movement of the fluid delivery member 118 with respect to the frame 128.

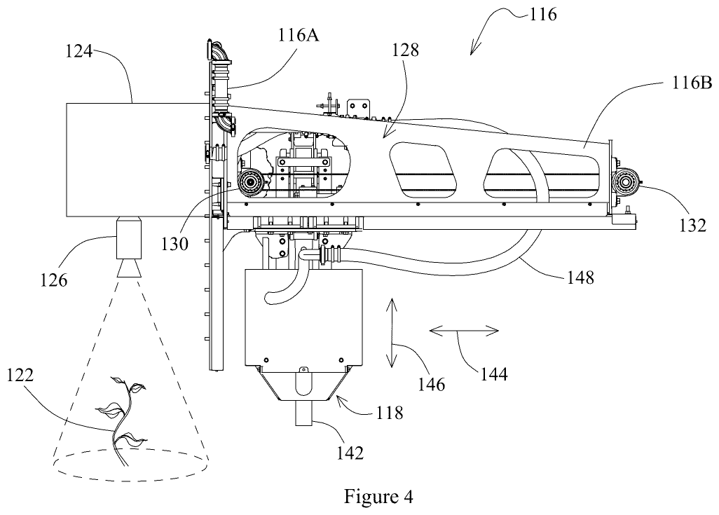

FIG. 4 illustrates the working of the vision-based irrigation system. As shown in FIG. 2, the work machine 100 is moving in a forward direction on ground 120, a sensor 126 looks onto the ground 120 ahead of the fluid delivery member 118 and captures the images or video of the ground 120 and saplings 122. In an embodiment, as shown in FIGS. 2 and 4 the sensor 126 is placed on frame block 124 between the fluid delivery member 118 and the hydrating fluid storage tank 110 of the work machine 100. In a further embodiment, the sensor 126 is placed at the second end 116B of the frame. In the described embodiment the sensor 126 may be a camera. However, any sensor 126 including but not limited to ultrasonic, laser, radar sensors which can recognize a sapling on ground could be used. The sensor 126 may further include an image analysis system to identify the sapling 122 from the image from the sensor 126. The sensor 126 may further record the position of the sapling 122. In an embodiment, the position of the sapling 122 is relative to a calibrated location on the chassis 106 of the work machine 100. However, the position of the sapling 122 could be of relative to the fluid delivery member 118 or absolute coordinates based on a GPS system. The sensor 126 may further record the speed of the work machine 100 and generate a signal 127 including the position of the sapling 122 and the speed of the work machine 100.

The hydrating control unit 102, upon receiving the signal 127 from sensor 126, controls the motor 134 speed and direction of rotation to control the position of the fluid delivery member 118 to maintain a non-relative motion with respect to the sapling 122 detected by the sensor 126. This mechanism allows positioning the nozzle 142 of the fluid delivery member 118 vertically above the sapling 122 for spraying water or hydrating fluid 110a.

The hydrating fluid 110a may comprise water, a hydrogel, a fertilizer, or some mixture thereof.

The input signal may be either electric, pneumatic, or hydraulic.

The target distribution rate of the hydrating fluid 110a may be based at least in part on a target volume of water or other hydrating fluid 110a. Target volume may be defined as the intended target volume of water release per sapling 122. The target volume optionally may be defined by the hydrating control unit 102 based on the signal 127 from sensor 126 or a vehicle control unit.

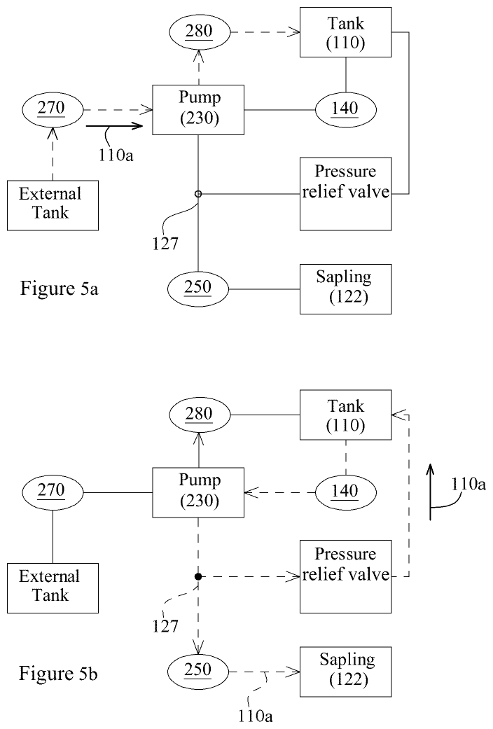

The hydrating control unit 102 may further determine a function mode for the hydrating fluid storage tank 110 between a refill mode (path designated by the dotted lines in FIG. 5a and a supply mode (path designated by the dotted lines in FIG. 5b). The function mode may be received through a function mode signal.

Selecting the designated function controls an access valve 270 fluidly disposed between the pump 230 and an external water source. The access valve 270 may toggle between an open position to fill the hydrating fluid storage tank 110 from an external hydrating fluid source (e.g. lake, reservoir) during refill mode, and a closed position to return the hydrating fluid 110a to the supply pressure during the supply mode.

The hydrating control unit 102 may further control a stop loss valve 280 fluidly disposed between the pump 230 and the hydrating fluid storage tank 110. The stop loss valve 280 toggles between a closed position when the function mode is in supply mode and an open position when the function mode is in refill mode. The release valve 250 is oriented towards the sapling 122. The input signal for the function mode may be received from a user input interface.

In an embodiment, the nozzle is fluidly connected to the hydrating fluid storage tank 110 by means of a hose 148 (FIG. 4). However, it is expected to add multiple hoses and valves for managing the flow within the work machine 100. The hydrating fluid 110a is continuously circulated from the hydrating fluid storage tank 110 to the nozzle 142 and back to the hydrating fluid storage tank 110 by the pump 230. The pump 230 may be run by an electric or hydraulic or pneumatic motor or any other motor may be used to drive the pump 230. In this system, nozzle 142 has a continuous supply of hydrating fluid 110a with pressure. As the fluid delivery member 118 is maintaining position above a sapling 122, the hydrating control unit 102 will open the nozzle 142 for a duration which may be based on the target amount of water or hydrating fluid 110a to be supplied for a sapling 122. Alternative embodiments are contemplated where the pump 230 is idle and driven for a duration to supply target water amount through nozzle 142.

In an embodiment, the nozzle 142 of the fluid delivery member 118 may have a plurality of nozzles. The plurality of nozzles are connected to the hydrating fluid storage tank 110 and the flow amount for each nozzle 142 is divided such that the total fluid sprayed by all nozzles is equal to the target fluid amount per sapling 122. The plurality of nozzles is arranged on the fluid delivery member 118 such that the water sprayed is distributed around the sapling 122 evenly or as per requirement.

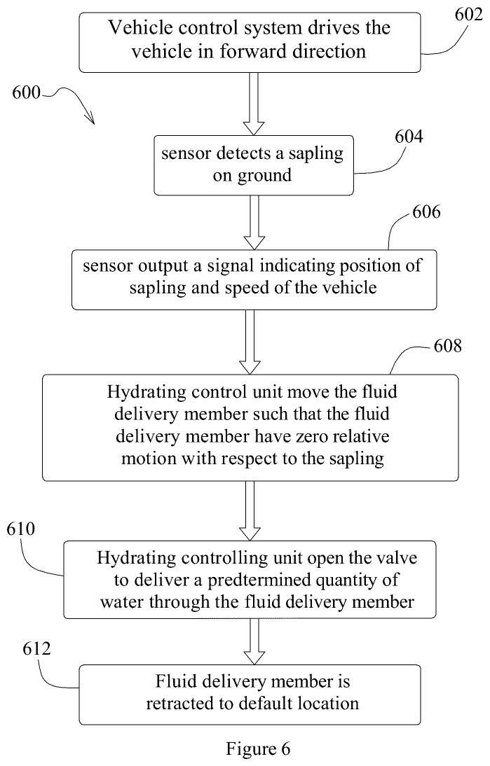

FIG. 6 is flowchart describing the sequence of events in an automatic irritation system 600. In a first step 602, the work machine 100 is driven in a silviculture field across a row of saplings/entities 122. In an embodiment, the hydrating control unit 102 may drive the work machine 100 according to predetermined path as discussed earlier. As the work machine 100 moves in a forward direction, the camera or sensor 126 attached to the vehicle chassis 106 captures the video/image of the ground 120. At step two 604, the image analysis system processes the video/image from the camera or sensor 126 and detects a sapling/entity 122 from the video and outputs a signal 127 at a third step 606. The signal may include the position of the sapling/entity 122 on ground 120 with respect to the chassis 106 and speed of the work machine 100. As a fourth step 608, the hydrating control unit 102 takes the signal including a sapling position and vehicle speed as inputs and moves the fluid delivery member 118 such that the fluid delivery member 118 maintains a zero relative motion with respect to the sapling/entity 122 on the ground 120. As the fluid delivery member 118 is positioned above the sapling/entity 122, at step five 610 the hydrating controlling unit 102 opens the valve to deliver a pre-determined quantity of water or hydrating fluid 110a through the nozzle 142 of fluid delivery member 118. Once the target quantity of water or hydrating fluid 110a is delivered to the sapling 122, at step six 612 the hydrating controlling unit 102 closes the nozzle 142 and retracts the fluid delivery member 118 to a default location. Steps one to six are continued in a loop as the work machine 100 is traversing in a field.

The present disclosure has several technical advancements, including but not limited to the realization of a vision-based detection of saplings, operating the fluid delivery member to maintain a non-relative motion with respect to the sapling while vehicle is moving forward, and high speed irrigation of saplings by a work machine.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A work machine for irrigation, the work machine comprising:
a chassis including ground-engaging elements to support the chassis on a ground;
a hydrating module coupled to the chassis, the hydrating module having a hydrating fluid storage tank, a fluid delivery member fluidly coupled to the hydrating fluid storage tank, a drive mechanism configured to move the fluid delivery member relative to the chassis, and a hydrating control unit; and
a sensor in communication with the hydrating control unit, the sensor configured to observe the ground and output a signal;
wherein the hydrating control unit, upon receiving the signal, controls a position of the fluid delivery member to maintain a non-relative motion with respect to a sapling on the ground and deliver a predetermined amount of a hydrating fluid to the sapling.

2. The work machine of claim 1, wherein a propulsion system is coupled to the chassis at a front end and the fluid delivery member is coupled to the chassis at a rear end.

3. The work machine of claim 1, wherein the sensor is coupled to the chassis forward or rearward of the fluid delivery member.

4. The work machine of claim 1, wherein the sensor comprises a camera to identify an entity.

5. The work machine of claim 4, wherein the signal comprises a position of the entity with respect to the chassis.

6. The work machine of claim 4, wherein the entity comprises a sapling.

7. The work machine of claim 1, wherein the fluid delivery member comprises a plurality of nozzles to distribute the hydrating fluid.

8. The work machine of claim 1, wherein the hydrating control unit is configured to steer the work machine according to a pre-determined path.

9. The work machine of claim 8, wherein the pre-determined path comprises a recorded path that was recorded during an earlier operation of the work machine.

10. The work machine of claim 1, wherein the drive mechanism comprises a belt.

11. A system for irrigating a silviculture field, the system comprising:
a work machine having a chassis and ground-engaging elements to support the chassis on a ground;
a hydrating module coupled to the chassis, the hydrating module having a hydrating fluid storage tank, a fluid delivery member fluidly coupled to the hydrating fluid storage tank, a drive mechanism configured to move the fluid delivery member relative to the chassis, and a hydrating control unit; and
a sensor in communication with he hydrating control unit, the sensor configured to observe the ground and output a signal;
wherein the hydrating control unit, upon receiving the signal, controls a position of the fluid delivery member to maintain a non-relative motion with respect to a sapling on the ground and deliver a predetermined amount of a hydrating fluid to the sapling.

12. The system of claim 11, wherein a propulsion system is coupled to the chassis at a front end and the fluid delivery member is coupled to the chassis at a rear end.

13. The system of claim 11, wherein the sensor is coupled to the chassis forward or rearward of the fluid delivery member.

14. The system of claim 11, wherein the sensor comprises a camera to identify an entity.

15. The system of claim 14, wherein the signal comprises a position of the entity with respect to the chassis.

16. The system of claim 14, wherein the entity comprises a sapling.

17. The system of claim 11, wherein the fluid delivery member comprises a plurality of nozzles to distribute the hydrating fluid.

18. The system according to claim 11, wherein the hydrating control unit is configured to steer the work machine according to a pre-determined path.

19. The system according to claim 18, wherein the pre-determined path comprises a recorded path that was recorded during an earlier operation of the work machine.

20. The system according to claim 11, wherein the drive mechanism comprises a belt.
